(19) United States
(12) Patent Application Publication
(10) Pub. No.: US 2018/0117759 A1
(43) Pub. Date: May 3, 2018

(54) CONVEYING ROBOT

(71) Applicant: Fanuc Corporation, Yamanashi (JP)

(72) Inventor: Takeshi HASUO, Yamanashi (JP)

(73) Assignee: Fanuc Corporation, Yamanashi (JP)

(21) Appl. No.: 15/726,997

(22) Filed: Oct. 6, 2017

(30) Foreign Application Priority Data
Oct. 28, 2016 (JP) 2016-211380

(51) Int. Cl. B25J 9/10; B25J 18/04; B25J 17/02; B25J 9/00

(52) U.S. Cl. CPC B25J 9/10; B25J 9/0009; B25J 17/02; B25J 18/04

(57) ABSTRACT

Installation space is made compact, a speed at which a workpiece is conveyed is enhanced, and interference with peripheral equipment is easily avoided. Provided is a conveying robot including: a base; a turning base that is provided so as to be rotatable about a first axis which is substantially vertical (perpendicular) with respect to the base; a first arm that is provided so as to be pivotable about a second axis substantially horizontal with respect to the turning base; and a second arm that is provided on the first arm so as to be movable along a longitudinal direction of the first arm and that supports, at a distal end thereof, a wrist unit that can hold a workpiece to be conveyed.

### CROSS-REFERENCE TO RELATED APPLICATIONS

This application is based on Japanese Patent Application No. 2016-211380, the contents of which are incorporated herein by reference.

### BACKGROUND

### Technical Field

The present invention relates to a conveying robot.

### History of Related Art

In the related art, there is a known multijoint conveying apparatus that is provided with, as a means of conveying a workpiece between press apparatuses, an arm that is disposed so as to be movable along a beam that is bridging supports of the press apparatuses themselves and so as to be suspended therefrom (for example, see Patent Literature 1).

There is a known conveying apparatus in which, between two arm support portions that are erected between press apparatuses on either side in the longitudinal direction of the press apparatuses, a crossbar that extends over the entire length of the press apparatuses is supported, and a workpiece holding apparatus supported by the crossbar is moved between the press apparatuses (for example, see Patent Literature 2).

There is a known conveying apparatus in which a vertical multijoint robot is disposed on a support base that is disposed between press apparatuses on one side in a longitudinal direction of the press apparatuses, and thus, handling of a workpiece between the press apparatuses is performed (for example, see Patent Literature 3).

There is also a known robot that moves an arm like a pendulum (for example, see Patent Literature 4).

There is also a known pendulum-type robot that is supported so as to be horizontally movable along a beam (for example, see Patent Literature 5).

There is also a known robot that can be installed even if a spacing between press machines is small (for example, see Patent Literature 6).

There is also a known robot that is provided with a second vertical arm that can be pivoted like a pendulum (for example, see Patent Literature 7).

### CITATION LIST

{PTL 1} Publication of Japanese Patent No. 5631805
{PTL 2} Publication of Japanese Patent No. 5603124
{PTL 3} Publication of Japanese Patent No. 3350496
{PTL 4} Publication of Japanese Patent No. 2934104
{PTL 5} Japanese Unexamined Patent Application, Publication No. Hei 9-70778
{PTL 6} Japanese Unexamined Patent Application, Publication No. 2004-337918
{PTL 7} Japanese Unexamined Patent Application, Publication No. 2007-130729

### SUMMARY

An object of various embodiments of the present invention is to provide a conveying robot with which the installation space can be made compact, and with which it is possible to enhance the speed at which a workpiece is conveyed and to easily avoid interference with peripheral equipment.

An embodiment of the present invention a conveying robot including: a base; a turning base that is provided so as to be rotatable about a first axis which is substantially vertical (perpendicular) with respect to the base; a first arm that is provided so as to be pivotable about a second axis substantially horizontal with respect to the turning base; and a second arm that is provided on the first arm so as to be movable along a longitudinal direction of the first arm and that supports, at a distal end thereof, a wrist unit that can hold a workpiece to be conveyed.

In the above-described embodiment, a motion range of the first arm about the second axis may be located in or below a substantially horizontal plane including the second axis.

In the above-described embodiment, the base may be installed so that the wrist unit is moved, by means of a pivoting motion of the first arm about the second axis, in substantially the same direction as the direction in which the workpiece is conveyed.

In the above-described embodiment, the wrist unit may be provided with at least two rotation shafts that intersect each other.

The above-described embodiment may be provided with a sliding arm having a substantially strip-shaped frame and a pair of sliders that are provided on either side of the frame in a thickness direction so as to be movable relative to each other along a longitudinal direction of the frame, wherein one of the sliders may be attached to the rotation shaft at a terminal end of the wrist unit.

In the above-described embodiment, the other slider may be provided with a distal-end pivoting shaft that allows a tool that grips the workpiece to pivot about an axis extending in the width direction of the frame.

The above-described embodiment may be provided with an attaching/detaching mechanism that is provided in a portion between the base and the tool so as to make the turning base, the first arm, the second arm, the wrist unit, the sliding arm, or the tool mechanically attachable/detachable together with electrical wiring by means of an electrical signal.

The above-described embodiment may be provided with, an attaching/detaching mechanism that makes the rotation shaft at the terminal end of the wrist unit and the sliding arm mechanically attachable/detachable together with electrical wiring between the two components by means of an electrical signal.

In the above-described embodiment, the base may include an installation surface disposed at a position away from the first axis.

In the above-described embodiment, the turning base may be rotationally driven by means of a motor that generates a driving force about a vertical (perpendicular) axis in the vicinity of the installation surface and a parallel four-bar linkage that transmits the driving force from the motor to the turning base.

### BRIEF DESCRIPTION OF THE DRAWINGS

FIG. 1 is a perspective view showing a conveying robot according to a first embodiment of the present invention.

FIG. 2 is a perspective view showing a conveying robot according to a second embodiment of the present invention.

FIG. 3 is a side view showing a sliding arm provided in the conveying robot in FIG. 2.

FIG. 4 is a perspective view showing a pressing system in which the conveying robot in FIG. 2 is placed between two press apparatuses.

FIG. 5 is a side view of the sliding arm for explaining the case in which, in the conveying robot in FIG. 2, an inclination angle of a tool is changed without moving an eighth shaft.

FIG. 6 is a perspective view of a conveying robot that is a modification of the conveying robot in FIG. 4 and that is provided with an attaching/detaching mechanism between a wrist unit and a sliding arm.

FIG. 7 is a perspective view showing a modification of the conveying robot in FIG. 1.

FIG. 8 is a perspective view showing a pressing system in which the conveying robot in FIG. 7 is placed between two press apparatuses.

### DETAILED DESCRIPTION OF ILLUSTRATIVE EMBODIMENTS

A conveying robot 1 according to a first embodiment of the present invention will be described below with reference to the drawings.

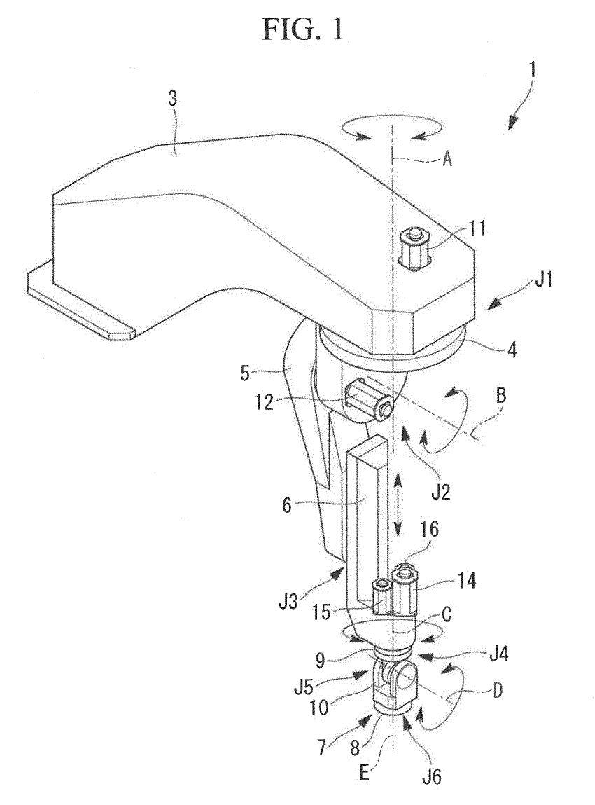

As shown in FIG. 1, the conveying robot 1 according to this embodiment is provided with: a base 3 that extends in one direction like a cantilever from an installation surface that is secured to a support base 2; a turning base 4 that is supported so as to allow turning thereof about a first axis A that is vertical (perpendicular) with respect to a distal end of the base 3; a first arm 5 that is supported so as to be pivotable about a second axis B that is horizontal to the turning base 4; a second arm 6 that is supported so as to be capable of rectilinear motion in a longitudinal direction of the first arm 5; and a wrist unit 7 that is disposed at a distal end of the second arm 6.

In other words, the conveying robot 1 is provided with: a first shaft J1 that allows the turning base 4 to horizontally turn about the first axis A with respect to the base 3; a second shaft J2 that allows the first arm 5 to pivot about the second axis B with respect to the turning base 4; a third shaft J3 that allows the second arm 6 to undergo rectilinear motion in the longitudinal direction of the first arm 5 with respect to the first arm 5; and the wrist unit 7.

As the wrist unit 7, two or more rotation shafts that are rotated about axes C, D, and E that intersect each other may be provided.

In this embodiment, the wrist unit 7 is constituted of a faceplate 8, a first wrist housing 9, and a second wrist housing 10 and is provided with three rotation shafts (a fourth shaft J4, a fifth shaft J5, and a sixth shaft J6) that are rotated about the axes C, D, and E that are orthogonal to each other, and the faceplate 8 for securing a tool or the like is disposed on the rotation shaft J6 at the terminal end. The fourth shaft J4 allows the first wrist housing 9 to rotate with respect to the second arm 6 about the fourth axis (rotation axis) C that is parallel to the longitudinal direction of the first arm 5; the fifth shaft J5 allows the second wrist housing 10 to rotate about the fifth axis (rotation axis) D that is orthogonal to the fourth axis C; and the sixth shaft J6 allows the faceplate 8 to rotate about the sixth axis (rotation axis) E that is orthogonal to the fifth axis D. In the figures, reference signs 11 to 16 are motors for the first shaft J1 to the sixth shaft J6, respectively.

Because the first shaft J1 allows the turning base 4 to horizontally turn about the vertical (perpendicular) first axis A, it is possible to change the direction in which the second axis B, which allows the first arm 5 to pivot, extends, that is, the plane in which the first arm 5 is pivoted.

Because the second shaft J2 allows the first arm 5 to pivot about the horizontal second axis B, the portion from the first arm 5 to the wrist unit 7 is pivoted like a pendulum. This pendulum-like motion range is located in or below a substantially horizontal plane including the second axis B. In the case in which a workpiece (not shown) is conveyed by means of the pendulum-like motion, because gravity always acts in the directions that assist acceleration and deceleration, it is possible to perform the pivoting motion caused by actuating the second shaft J2 at high speed and in an energy saving manner.

The third shaft J3 is configured so that the entire length of the arm constituted of the first arm 5 and the second arm 6 can be extended and contracted by rectilinearly moving the second arm 6 with respect to the first arm 5.

In other words, by using the first shaft J1 to the third shaft J3, it is possible to place the wrist unit 7 at an arbitrary position in the motion range. Also, by using the fourth shaft J4 to the sixth shaft J6, it is possible to arbitrarily adjust the orientation of the workpiece to be attached to the faceplate 8.

The operation of the thus-configured conveying robot 1 according to this embodiment will be described below.

With the conveying robot 1 according to this embodiment, it is possible to perform pendulum-like pivoting motions of the first arm 5 and the second arm 6 about the second axis B by means of the motion of the second shaft J2, and thus, it is possible to move the wrist unit 7, which is disposed at the distal end of the second arm 6, in a substantially horizontal direction below the second axis B. Therefore, by aligning the conveying direction with this substantially horizontal direction, it is possible to convey the workpiece substantially in the horizontal direction.

In this case, when conveying the workpiece by means of the pendulum-like motion, by causing gravity to always act in the directions that assist acceleration and deceleration thereof, it is possible to perform the pivoting motion caused by actuation of the second shaft J2 at high speed and in an energy saving manner. By doing so, there is an advantage in that it is possible to enhance the conveying speed.

In this embodiment, in a state in which the first arm 5 is moved to a position at which the first arm 5 becomes substantially horizontal, by aligning the longitudinal direction of the first arm 5 with the direction in which the base 3 extends by rotating the turning base 4 in any direction by 90°, it is possible to achieve a compact form that is suitable for conveying the conveying robot 1 by disposing the entire conveying robot 1 above the installation surface in the base 3.

Although simply pivoting the first arm 5 about the second axis B moves the wrist unit 7 along an arc-shaped trajectory, by combining the rotation of the turning base 4 and the pivoting of the first arm 5 with the rectilinear motion of the second arm 6 caused by the second shaft J2, it is possible to move the wrist unit 7 along a rectilinear trajectory. By doing so, it is possible to considerably reduce interference with peripheral equipment when conveying the workpiece.

In this embodiment, because a so-called inline wrist, in which the three rotation axes C, D, and E that are orthogonal to each other are compactly arranged, is employed as the wrist unit 7, it is possible to dispose the workpiece in freely set position and orientation by means of the six shafts J1, J2, J3, J4, J5, and J6, including the first shaft J1 to the third shaft J3, and thus, there is an advantage in that high versatility is achieved.

Next, a conveying robot 30 according to a second embodiment of the present invention will be described below with reference to the drawings.

In describing this embodiment, portions having common configurations with those of the conveying robot 1 according to the above-described first embodiment will be assigned the same reference signs, and descriptions thereof will be omitted.

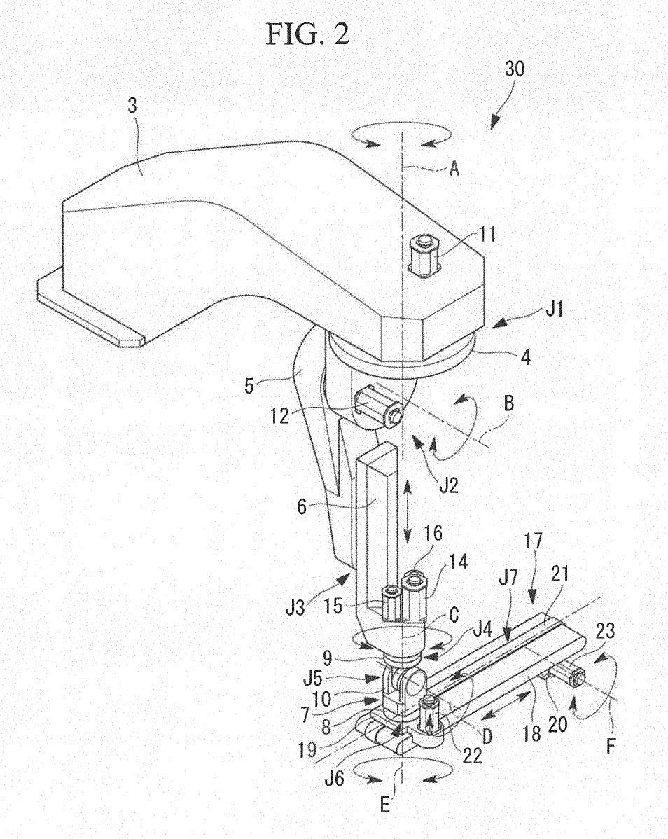

As shown in FIGS. 2 to 5, the conveying robot 30 according to this embodiment differs from the conveying robot 1 according to the first embodiment in that a sliding arm 17 is attached to the sixth shaft J6, which corresponds to the rotation axis E at the terminal end of the wrist unit 7.

The sliding arm 17 is provided with a frame 18 having a strip-shaped (rectangular flat plate-like) form, and sliders 19 and 20 that are disposed on either side of the frame 18 in the thickness direction.

The two sliders 19 and 20 are linked by a belt 21 that is threaded over pulleys (not shown) that are supported at both ends of the frame 18 in the longitudinal direction so as to be rotatable about axes that are parallel to each other. When the slider 19 is moved in one direction in the longitudinal direction of the frame 18 by being driven by a motor 22, the other slider 20 linked therewith by means of the belt 21 is moved, at the back side of the frame 18, in the other direction in the longitudinal direction. The seventh shaft J7 is thus constituted in this manner.

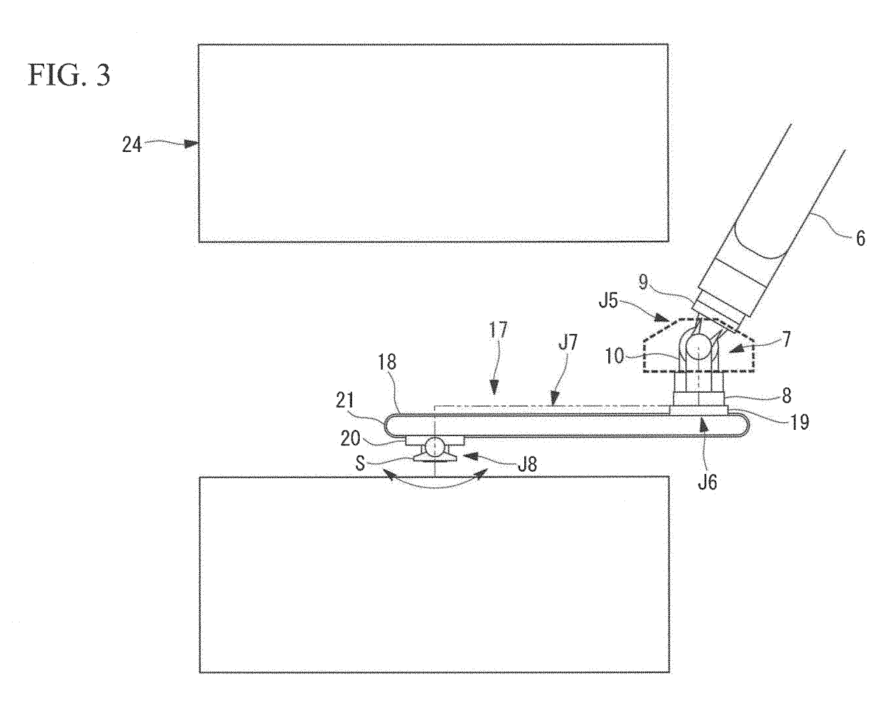

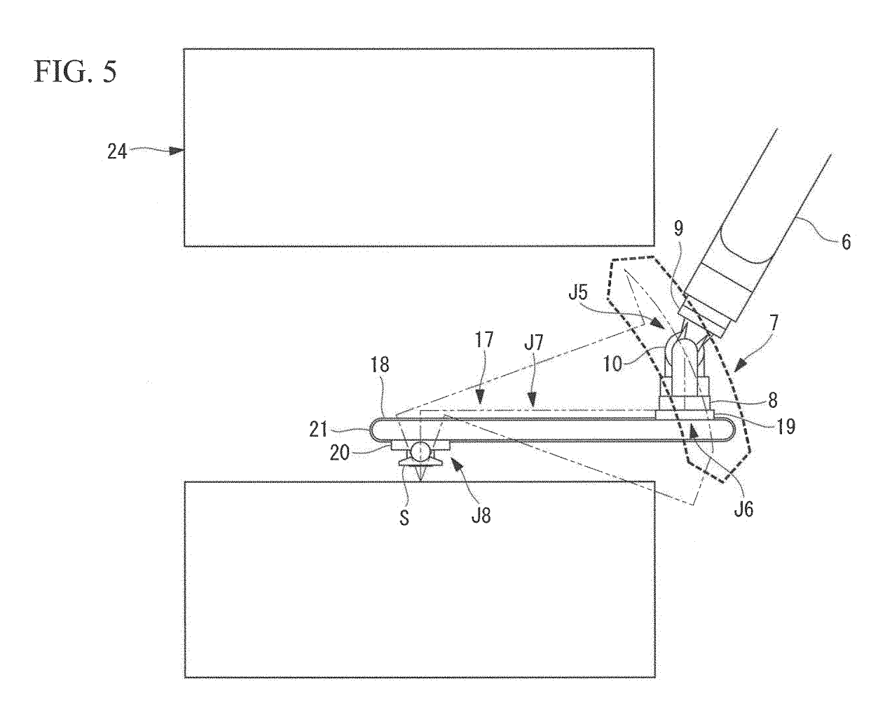

Also, by doing so, the two sliders 19 and 20 are moved relative to each other in opposite directions along the longitudinal direction of the frame 18. The slider 19 that is driven by the motor 22 is secured to the sixth shaft J6 of the wrist unit 7. As shown in FIGS. 3 and 5, the other slider 20 is provided with a tool S that grips the workpiece and an eighth shaft (distal-end pivoting shaft) J8 that allows the tool S to pivot about an eighth axis F, which extends in the width direction of the frame 18, by means of a motor 23. The broken line in FIG. 3 indicates a motion range of the wrist unit 7 for gripping the workpiece by using the tool S.

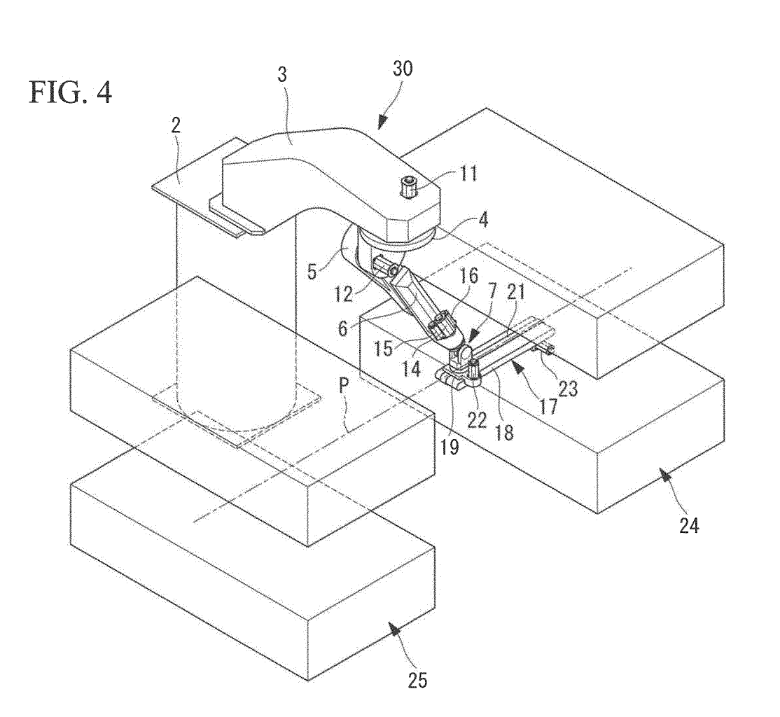

The operation of the thus-configured conveying robot 30 according to this embodiment will now be described, in particular, in terms of a case in which a workpiece is supplied to and taken out from a space between two press apparatuses 24 and 25 that are adjacent to each other with a spacing therebetween, as in a pressing system shown in FIG. 4.

As shown in FIGS. 2 and 3, with the conveying robot 30 according to this embodiment, by positioning all of the shafts J1, J2, J3, J4, J5, J6, J7, and J8 at the origin, the first arm 5 and the second arm 6 are extended vertically (perpendicularly) downward and the sliding arm 17 is disposed substantially horizontally. Also, by moving the second arm 6 to a predetermined position in the longitudinal direction of the first arm 5, the center of the sliding arm 17 in the width direction is disposed so as to be placed on a straight line (press center line) P that connects the centers of the press apparatuses 24 and 25.

Next, as shown in FIG. 4, by rotating the first arm 5 about the second axis B in one direction with respect to the turning base 4, the first arm 5 and the second arm 6 are moved like a pendulum, and the individual rotation shafts J4, J5, and J6 of the wrist unit 7 are moved, and thus, the sliding arm 17 is moved along the press center line P while maintaining the substantially horizontal orientation of the sliding arm 17, and while maintaining the longitudinal direction and the width direction in steady directions. At this time, by actuating the seventh shaft J7 of the sliding arm 17, the two sliders 19 and 20 are moved relative to each other so that frame 18 of the sliding arm 17 extends forward in the direction in which the first arm 5 is pivoted.

By doing so, in a state in which the wrist unit 7 is disposed outside the press apparatuses 24 and 25, it is possible to insert only the sliding arm 17 into the press apparatus 24. Then, in this position, it is possible to grip the workpiece, for example, a sheet of metal for which one step in pressing has been completed, in the press apparatus 24 by using the tool S provided in the slider 19 and to remove the workpiece from a metal mold (not shown) in the press apparatus 24.

In this state, the orientation of the sliding arm 17 is maintained by moving the wrist unit 7 by bringing the wrist unit 7 close to the other press apparatus 25 by moving the first arm 5 and the second arm 6 like a pendulum, and the two sliders 19 and 20 are moved relative to each other, by actuating the sliding arm 17, so that the frame 18 of the sliding arm 17 and the workpiece gripped by using the tool S are inserted into the other press apparatus 25. In this case also, because the sliding arm 17 is moved along the press center line P, it is possible to transfer the workpiece to a metal mold in the other press apparatus 25 by releasing the conveyed workpiece by actuating the tool S.

In other words, the sliding arm 17 has a strip-shaped frame 18, and it can be configured so as to have a thickness that is satisfactorily small as compared with that of the wrist unit 7. Therefore, even in a small gap between the metal molds that are separated at the top and bottom in the press apparatuses 24 and 25, it is possible to easily insert the sliding arm 17 into the gap and to grip or release the workpiece therein.

In particular, in the case in which the workpiece is conveyed between the press apparatuses 24 and 25, there is a demand to improve the efficiency of the pressing step by advancing the tool S for gripping the workpiece immediately after the metal molds in the press apparatuses 24 and 25 start to be separated and by retracting the tool S from the press apparatuses 24 and 25 immediately before the metal molds are closed. Therefore, the sliding arm 17 having a small thickness is suitable as a mechanism for entering the press apparatuses 24 and 25.

Because the wrist unit 7 is moved along a rectilinear trajectory by means of pivoting of the first arm 5 and rectilinear motion of the second arm 6 while maintaining a stable orientation of the sliding arm 17 by using the wrist unit 7 having the three shafts J4, J5, and J6, it is possible to move the sliding arm 17 in the same plane, and thus, there is an advantage in that it is possible to avoid interference between the individual portions of the press apparatuses 24 and 25 and the sliding arm 17.

By rectilinearly moving the second arm 6 straight with respect to the first arm 5 in the longitudinal direction thereof, it is possible to constantly keep the form of the entire arm constituted of the first arm 5 and the second arm 6 substantially straight, and thus, there is an advantage in that it is possible to avoid interference between the individual portions of the first arm 5 and the second arm 6 and the individual portions of the press apparatuses 24 and 25 or peripheral equipment.

Because the sliding arm 17 horizontally moves the frame 18 by moving the two sliders 19 and 20 relative to each other in the horizontal direction, by aligning the direction in which the frame 18 is moved with the direction in which the workpiece is conveyed, there is an advantage in that it is possible to convey the workpiece at high speed by actuating the sliding arm 17 even if the wrist is not moved by a large amount when conveying the workpiece.

In the conveying robot 30 according to this embodiment, of the two sliders 19 and 20 of the sliding arm 17, because the tool S is attached, via the eighth shaft J8, to the slider 20, which is disposed on the opposite side of the frame 18 with respect to the slider 19 secured to the sixth shaft J6 of the wrist unit 7, it is possible to change, by moving the eighth shaft J8, the angle of the tool S about the eighth axis F along the width direction of the frame 18.

Because of the increased diversity of shapes of workpieces to be pressed, the direction in which a workpiece is removed from the metal molds in the press apparatuses 24 and 25 is not limited to the vertical (perpendicular) direction. In such a case, as shown in FIG. 3, by inclining the tool S by moving the eighth shaft J8, it is possible to align the inclination of the tool S with the direction in which the workpiece is removed without changing the orientation of the sliding arm 17.

Even if the eighth shaft J8 is not used, or in the case in which the eighth shaft J8 is not provided, as shown in FIG. 5, changes in the inclination of the tool S cause, in association therewith, changes in the orientation of the sliding arm 17 caused by changes in the position of the wrist unit 7 of the conveying robot 30, and thus, the likelihood of interference occurring between the second arm 6, the wrist unit 7, and the sliding arm 17 and the press apparatuses 24 and 25 or peripheral equipment is increased. The broken line in FIG. 5 indicates a motion range of the wrist unit 7 for gripping the workpiece by using the tool S.

In other words, with the conveying robot 30 according to this embodiment, as shown in FIG. 3, by providing the eighth shaft J8, it is possible to easily avoid interference between the conveying robot 30 and the press apparatuses 24 and 25 or peripheral equipment, and thus, there is an advantage in that, by minimizing the movements of the turning base 4, the first arm 5, the second arm 6, and the wrist unit 7 for changing the angle of the tool S, it is possible to prevent an increase in the conveying time.

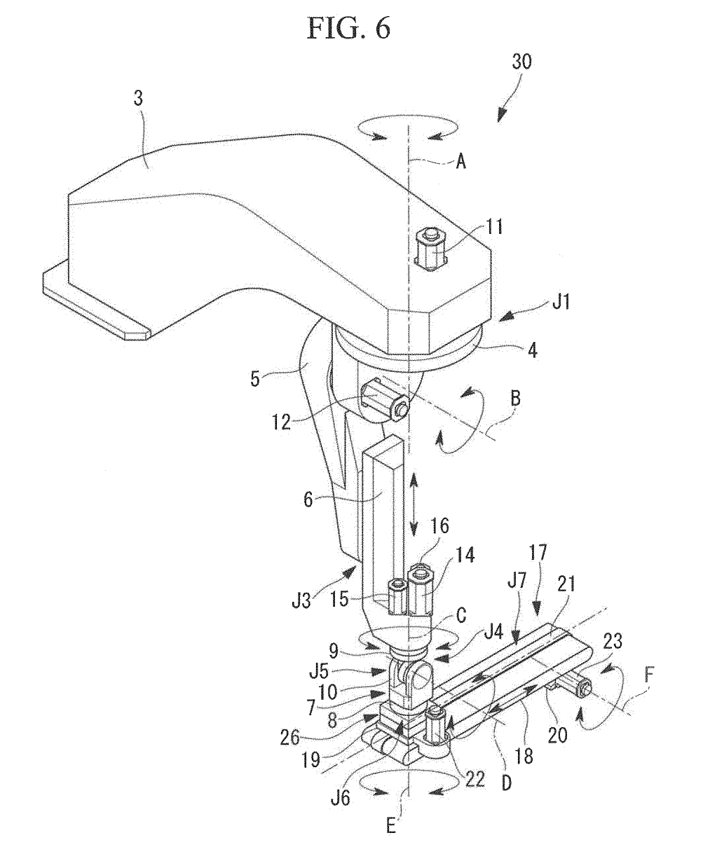

As shown in FIG. 6, this embodiment may be provided with an attaching/detaching mechanism 26 that is disposed between the wrist unit 7 and the sliding arm 17 and that mechanically attaches/detaches the slider 19 of the sliding arm 17 to/from the sixth shaft J6 of the wrist unit 7.

With a single press apparatus 24, pressing of diverse workpieces is generally performed by exchanging metal molds, and it is necessary to provide tools S having different shapes in accordance with the shapes of the workpieces. Therefore, by preparing a plurality of sliding arms 17 provided with the tools S having different shapes and by changing the tools S in accordance with the sliding arms 17 by actuating the attaching/detaching mechanism 26, it is possible to cope with pressing of diverse workpieces.

Although a publically known structure may be employed as the attaching/detaching mechanism 26, in order to move the seventh shaft J7 and the eighth shaft J8 provided in the sliding arm 17, at least electrical wiring (not shown) also needs to be mechanically attachable/detachable by means of electrical signals. In the case in which it is necessary to supply a fluid to the sliding arm 17, a flow channel (not shown) for the fluid may also be provided so as to be attachable/detachable.

By providing the attaching/detaching mechanism 26, the amount of time required to change the setup associated with changes in the workpieces to be processed is reduced by quickly exchanging the tools S, and thus, there is an advantage in that the pressing productivity is consequently enhanced.

In this case, because the attaching/detaching mechanism 26 has a constant thickness, the thickness of a portion to be inserted into the press apparatuses 24 and 25 is increased in the case in which the attaching/detaching mechanism 26 is disposed between a faceplate (not shown) and the tool S, which are provided at the distal end of the eighth shaft J8 of the sliding arm 17, and thus, this configuration is not preferable. With this embodiment, because the attaching/detaching mechanism 26 is provided between the wrist unit 7 and the slider 19, which are not inserted into the press apparatuses 24 and 25, the thickness of the portion to be inserted into the press apparatuses 24 and 25 can be kept small.

The placement of the attaching/detaching mechanism 26 is not limited to between the sixth shaft J6 and the slider 19, and the attaching/detaching mechanism 26 may be disposed in the portion between the base 3 and the tool S so as to make the turning base 4, the first arm 5, the second arm 6, the wrist unit 7, the sliding arm 17 or the tool S mechanically attachable/detachable together with electrical wiring by means of electrical signals.

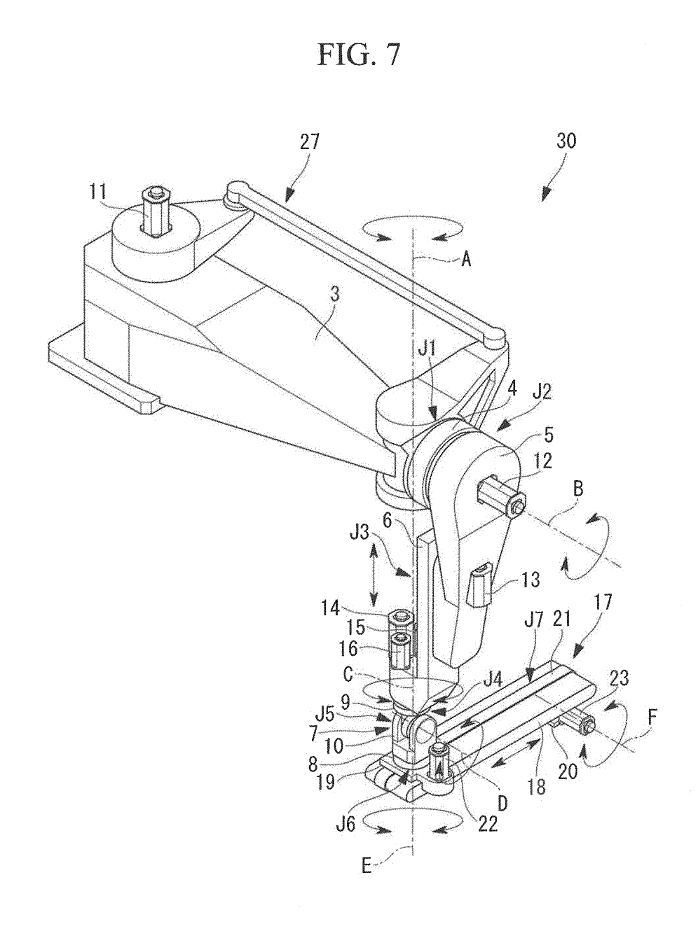

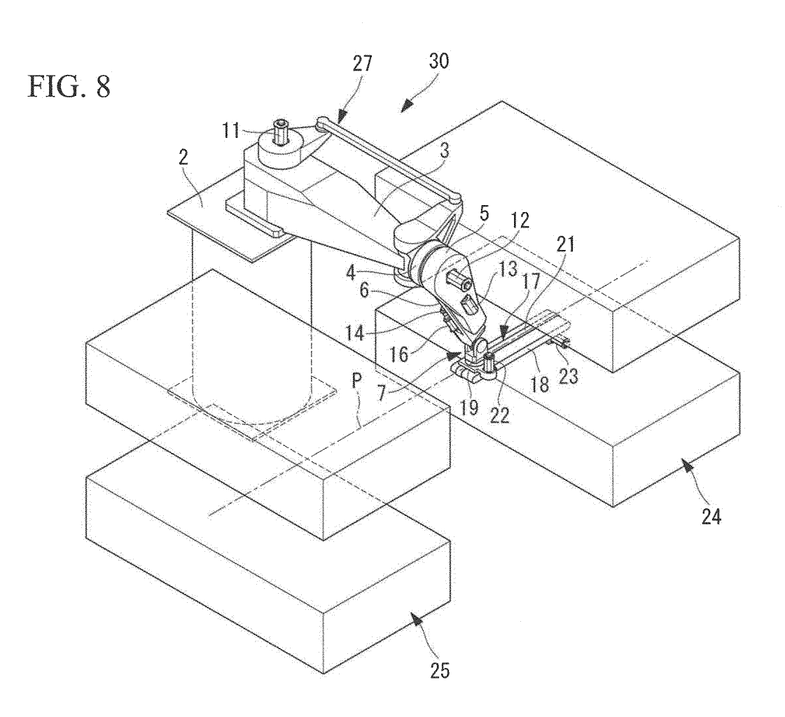

In this embodiment, although a motor 11 that generates a driving force about a vertical (perpendicular) axis, a reduction gear (not shown) that transmits the driving force from the motor 11 to the turning base 4 after amplifying the driving force, and so forth are provided in the vicinity of the distal end of the base 3 that extends like a cantilever from the support base 2, alternatively, as shown in FIGS. 7 and 8, the installation surface in the base 3 may be disposed at a position away from the first axis A, the motor 11 and the reduction gear may be disposed in the vicinity of the installation surface in the base 3, and the driving force from the motor 11 may be transmitted to the turning base 4 disposed at the distal end of the base 3 by means of a parallel four-bar linkage 27. By doing so, the motor 11, the reduction gear, and so forth, which are constituted of heavy objects, are disposed on the base-end side of the base 3, and thus, there is an advantage in that it is possible to reduce the load exerted on the base 3 and the support base 2.

As a result, the following aspect is read from the above described embodiment of the present invention.

An aspect of the present invention a conveying robot including: a base; a turning base that is provided so as to be rotatable about a first axis which is substantially vertical (perpendicular) with respect to the base; a first arm that is provided so as to be pivotable about a second axis substantially horizontal with respect to the turning base; and a second arm that is provided on the first arm so as to be movable along a longitudinal direction of the first arm and that supports, at a distal end thereof, a wrist unit that can hold a workpiece to be conveyed.

With this aspect, the workpiece is held by using the wrist unit, the direction of the second axis is set by the turning base, the wrist unit is moved between two positions that are away from each other toward each side of the first axis by pivoting the first arm about the second axis, and thus, the workpiece can be conveyed. At this time, pivoting of the first arm can be performed in a pendulum-like motion by utilizing the gravitational force of the first arm, the second arm, and the wrist unit.

Therefore, it is possible to perform pivoting of the second arm with high acceleration/deceleration, and thus, it is possible to convey the workpiece at high speed. Also, by moving the second arm in the longitudinal direction of the first arm in accordance with pivoting of the first arm, it is possible to move the workpiece rectilinearly in a substantially horizontal direction.

Regarding installation of the base that supports the turning base disposed perpendicularly above the motion trajectory of the wrist, it is possible to utilize a simple mount relatively freely, and it is also possible to make the installation space compact.

In the above-described aspect, a motion range of the first arm about the second axis may be located in or below a substantially horizontal plane including the second axis.

By doing so, it is possible to limit pivoting of the first arm to the pendulum-like rotational motion, and it is possible to convey the workpiece at high speed by realizing high acceleration/deceleration. By pivoting the first arm to a substantially horizontal position by means of pivoting of the first arm, it is possible to realize a compact conveying form.

In the above-described aspect, the base may be installed so that the wrist unit is moved, by means of a pivoting motion of the first arm about the second axis, in substantially the same direction as the direction in which the workpiece is conveyed.

By doing so, it is possible to convey the workpiece at high speed by means of pendulum-like rotational motions of the first arm and the second arm caused by pivoting of the first arm about the second axis with respect to the turning base.

In the above-described aspect, the wrist unit may be provided with at least two rotation shafts that intersect each other.

By doing so, it is possible to maintain a stable orientation of the workpiece, which is attached to the distal end of the wrist unit disposed at an arbitrary position, by means of pivoting of the first arm and rectilinear motion of the second arm.

The above-described aspect may be provided with a sliding arm having a substantially strip-shaped frame and a pair of sliders that are provided on either side of the frame in a thickness direction so as to be movable relative to each other along a longitudinal direction of the frame, wherein one of the sliders may be attached to the rotation shaft at a terminal end of the wrist unit.

By doing so, by holding the workpiece in an attachable/detachable manner by using the slider that is disposed on the opposite side in the thickness direction of the frame with respect to the slider attached to the rotation shaft at the terminal end of the wrist unit, it is possible to extend the strip-shaped thin frame in the longitudinal direction thereof in the conveying direction, and thus, it is possible to make the workpiece undergo reciprocating motion in the longitudinal direction of the frame with respect to the wrist unit.

By doing so, when attaching/detaching the workpiece, because it is necessary just to insert the strip-shaped thin frame without having to dispose the wrist unit in the vicinity of the workpiece, the space around the workpiece required to attach/detach the workpiece does not need to be made large, and thus, it is possible to easily avoid interference with peripheral equipment. It is possible to supplement the pivoting motions of the first arm by means of the reciprocating motions of the slider caused by the sliding arm, and thus, by decreasing the motion range of the first arm, it is possible to avoid interference with peripheral equipment and to enhance the conveying speed.

In the above-described aspect, the other slider may be provided with a distal-end pivoting shaft that allows a tool that grips the workpiece to pivot about an axis extending in the width direction of the frame.

By doing so, by actuating the distal-end pivoting shaft provided in the slider, it is possible to change the angle of the tool that grips the workpiece without having to change the orientation of the sliding arm. As a result, even in the case in which it is necessary to convey the workpiece while inclining the workpiece, it is possible to avoid interference between the sliding arm and peripheral equipment by maintaining the orientation of the sliding arm, and thus, it is possible to minimize the movements of the first arm, the second arm, and the wrist unit.

The above-described aspect may be provided with an attaching/detaching mechanism that is provided in a portion between the base and the tool so as to make the turning base, the first arm, the second arm, the wrist unit, the sliding arm, or the tool mechanically attachable/detachable together with electrical wiring by means of an electrical signal.

The above-described aspect may be provided with, an attaching/detaching mechanism that makes the rotation shaft at the terminal end of the wrist unit and the sliding arm mechanically attachable/detachable together with electrical wiring between the two components by means of an electrical signal.

By doing so, the attaching/detaching mechanism, which is required to have a relatively large size, is disposed between the wrist unit and the sliding arm, and thus, it is not necessary to dispose the attaching/detaching mechanism in the vicinity of the workpiece. As a result, in the case in which the gripping tools for gripping the workpiece are exchanged by using the attaching/detaching mechanism in accordance with the type of the workpieces, it is not necessary to form a large space in the vicinity of the workpiece.

In the above-described aspect, the base may include an installation surface disposed at a position away from the first axis.

By doing so, the base is installed at one location away from the workpiece, the portions of the robot at the turning base and thereafter are supported by the base extending like a cantilever in a suspended state, and thus, by reducing the space occupied by the robot and by preventing an increase in the size of the system, the space required for maintenance can be made large, while reducing costs.

In the above-described aspect, the turning base may be rotationally driven by means of a motor that generates a driving force about a vertical (perpendicular) axis in the vicinity of the installation surface and a parallel four-bar linkage that transmits the driving force from the motor to the turning base.

By doing so, heavy objects such as a motor for driving the turning base or the like are disposed in the vicinity of the installation surface, and thus, it is possible to reduce the weight of the rest of the robot suspended at the distal end of the cantilever-like base.

### REFERENCE SIGNS LIST

1, 30 conveying robot
3 base
4 turning base
5 first arm
6 second arm
7 wrist unit
11 motor
17 sliding arm
18 frame
19, 20 slider
26 attaching/detaching mechanism
27 parallel four-bar linkage
A first axis
B second axis
C fourth axis (rotation axis)
D fifth axis (rotation axis)
E sixth axis (rotation axis)
S tool
J8 eighth shaft (distal-end pivoting shaft)

1. A conveying robot comprising:
a base;
a turning base rotatable about a first axis that is substantially vertical (perpendicular) with respect to the base;
a first arm pivotable about a second axis substantially horizontal with respect to the turning base; and
a second arm movable along a longitudinal direction of the first arm and that supports, at a distal end thereof, a wrist unit that can hold a workpiece to be conveyed.

2. The conveying robot according to claim 1, wherein a motion range of the first arm about the second axis is located in or below a substantially horizontal plane including the second axis.

3. The conveying robot according to claim 2, wherein the base is installed so that the wrist unit is moved, via a pivoting motion of the first arm about the second axis, in substantially the same direction as the direction in which the workpiece is conveyed.

4. The conveying robot according to claim 1, wherein the wrist unit is provided with at least two rotation shafts whose axes intersect each other.

5. The conveying robot according to claim 4, further comprising:
a sliding arm having a substantially strip-shaped frame and a pair of sliders on either side of the strip-shaped frame in a thickness direction so as to be movable relative to each other along a longitudinal direction of the frame; and
wherein one of the sliders is attached to the rotation shaft at a terminal end of the wrist unit.

6. The conveying robot according to claim 5, wherein the other slider is provided with a distal-end pivoting shaft that allows a tool that grips the workpiece to pivot about an axis extending in the width direction of the frame.

7. The conveying robot according to claim 6, further comprising an attaching/detaching mechanism that is provided in a portion between the base and the tool so as to make the turning base, the first arm, the second arm, the wrist unit, the sliding arm, or the tool mechanically attachable/detachable together with electrical wiring via an electrical signal.

8. The conveying robot according to claim 5, further comprising an attaching/detaching mechanism that makes the rotation shaft at the terminal end of the wrist unit and the sliding arm mechanically attachable/detachable together with electrical wiring between the two components via an electrical signal.

9. A The conveying robot according to claim 1, wherein the base comprises an installation surface disposed at a position away from the first axis.

10. The conveying robot according to claim 9, wherein the turning base is rotationally driven via a motor that generates a driving force about a vertical (perpendicular) axis in the vicinity of the installation surface and a parallel four-bar linkage that transmits the driving force from the motor to the turning base.
